(19) United States
(12) Patent Application Publication
(10) Pub. No.: US 2025/0246081 A1
(43) Pub. Date: Jul. 31, 2025

(54) EFFICIENT ROUTE PLANNING FOR AUTONOMOUS VEHICLES

(71) Applicant: WING AVIATION LLC, Mountain View, CA (US)

(72) Inventors: Sai Bhargav Yalamanchi, Mountain View, CA (US); Aditya Undurti, Dublin, CA (US); Matthieu Capuano, Mountain View, CA (US); Kevin Jenkins, Dallas, TX (US); Wouter Van Gijseghem, Stanford, CA (US); Ali Shoeb, San Rafael, CA (US); Stephen Lacy, Mountain View, CA (US)

(21) Appl. No.: 18/426,219

(22) Filed: Jan. 29, 2024

(51) Int. Cl. G08G 5/00; G08G 5/04

(52) U.S. Cl. CPC G08G 5/34; G08G 5/55; G08G 5/57; G08G 5/59; G08G 5/80

(57) ABSTRACT

In some embodiments, a method of planning a navigation route for an autonomous vehicle is provided. A computing system receives mission information including a start location and a goal location. The computing system generates a representation of an operation area that includes the start location and the goal location. The computing system updates the representation of the operation area based on one or more temporary obstacles. The computing system provides the representation of the operation area, the start location, and the goal location as input to a machine-learning model to generate a cost-to-go map of the operation area. The computing system determines the navigation route using the cost-to-go map of the operation area.

### TECHNICAL FIELD

This disclosure relates generally to route planning for autonomous vehicles, and in particular but not exclusively, relates to route planning for unmanned aerial vehicles (UAVs).

### BACKGROUND

Traditional techniques for planning routes for autonomous vehicles utilize sampling of potential routes from a start location to a goal location to determine one or more feasible routes. Unfortunately, such techniques typically use a large number of sampling iterations before feasible routes are found, resulting in larger wall clock time than desired. This problem is particularly acute in the context of managing a fleet of UAVs tasked to travel ad-hoc routes between many potential pairs of start locations and goal locations, such as when managing a fleet of UAVs to provide package delivery services, at least because such a system will have many different routes to be planned. While parallelization can often reduce the wall clock time of intensive computing tasks, parallelization is not typically effective in reducing wall clock time of traditional route planning techniques, as lock contention and context switching overhead often leads to an overall slowdown instead of an improvement.

What is desired are route planning techniques that are efficient enough to be useful for managing fleets of autonomous vehicles.

### BRIEF SUMMARY

In some embodiments, a method of planning a navigation route for an autonomous vehicle is provided. A computing system receives mission information including a start location and a goal location. The computing system generates a representation of an operation area that includes the start location and the goal location. The computing system updates the representation of the operation area based on one or more temporary obstacles. The computing system provides the representation of the operation area, the start location, and the goal location as input to a machine-learning model to generate a cost-to-go map of the operation area. The computing system determines the navigation route using the cost-to-go map of the operation area.

In some embodiments, a non-transitory computer-readable medium having computer-executable instructions stored thereon is provided. The instructions, in response to execution by one or more processors of a computing system, cause the computing system to perform actions for planning a navigation route for an autonomous vehicle, the actions comprising: receiving, by the computing system, mission information including a start location and a goal location; generating, by the computing system, a representation of an operation area that includes the start location and the goal location; updating, by the computing system, the representation of the operation area based on one or more temporary obstacles; providing, by the computing system, the representation of the operation area, the start location, and the goal location as input to a machine-learning model to generate a cost-to-go map of the operation area; and determining, by the computing system, the navigation route using the cost-to-go map of the operation area.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1A and FIG. 1B illustrate an aerial vehicle or UAV 100, in accordance with an embodiment of the present disclosure.

FIG. 2 is a block diagram that illustrates further components of a non-limiting example embodiment of a UAV according to various aspects of the present disclosure.

FIG. 3 is a block diagram that illustrates aspects of a non-limiting example embodiment of a flight planning computing system according to various aspects of the present disclosure.

FIG. 4 is a flowchart that illustrates a non-limiting example embodiment of a method of training a machine-learning model to generate cost-to-go maps of operation areas according to various aspects of the present disclosure.

FIG. 5A-FIG. 5D are simplified schematic illustrations of a non-limiting example embodiment of the determination of a cost-to-go map according to various aspects of the present disclosure.

FIG. 6 is a flowchart that illustrates a non-limiting example embodiment of a method of planning and traversing a navigation route using a cost-to-go map according to various aspects of the present disclosure.

### DETAILED DESCRIPTION

In some embodiments of the present disclosure, a “one-shot” sampler is used to greatly speed up both route planning and feasibility determinations for planning flights for a fleet of UAVs. The one-shot sampler is a sampler from which a feasible, best-effort (not necessarily optimal) route can be constructed with all of the samples lying on a solution path (if one exists). The one-shot sampler obviates the need for the large number of iterations used in a traditional sampling-based route determination technique, thereby reducing overall planning latency. In some embodiments, techniques are used that recover a cost function that underlies behavior of an expert route planner. If the cost function encodes cost-to-go to the goal location (with the cost corresponding to battery usage or other variables relating to a range of a UAV), such cost functions can be used directly to answer feasibility queries.

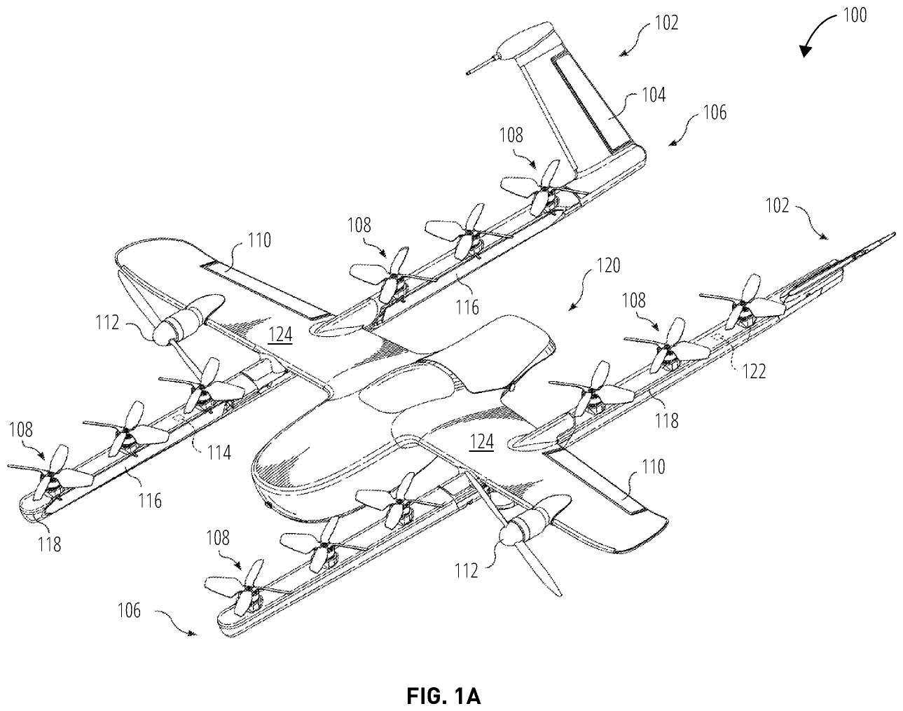

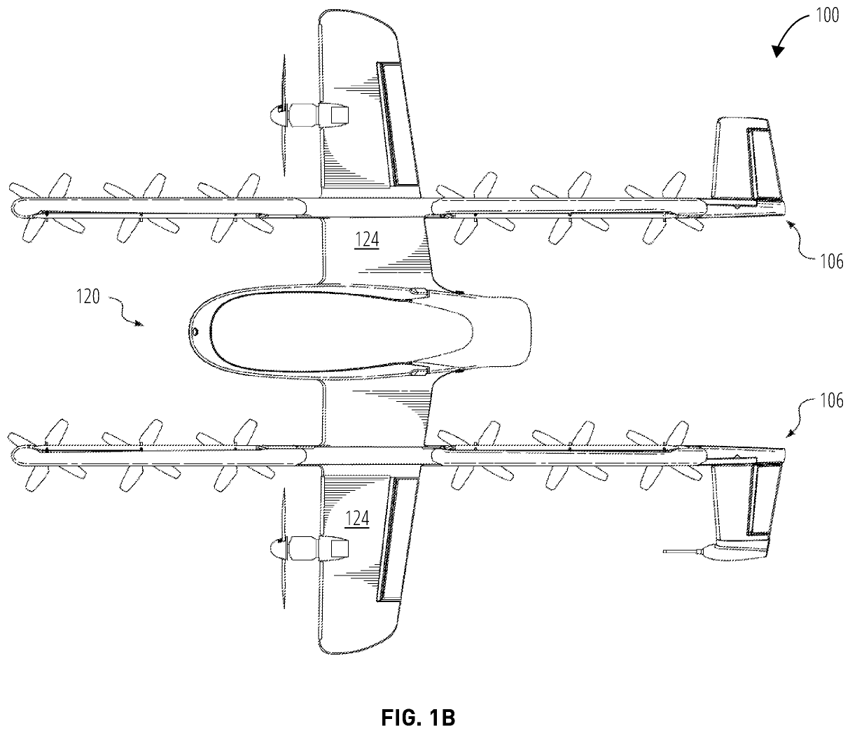

FIG. 1A and FIG. 1B illustrate an aerial vehicle or UAV 100, in accordance with an embodiment of the present disclosure. The illustrated embodiment of UAV 100 is a vertical takeoff and landing (VTOL) unmanned aerial vehicle (UAV) that includes separate propulsion units 112 and propulsion units 108 for providing horizontal and vertical propulsion, respectively. UAV 100 is a fixed-wing aerial vehicle, which as the name implies, has a wing assembly 124 that can generate lift based on the wing shape and the vehicle's forward airspeed when propelled horizontally by propulsion units 112. FIG. 1A is a perspective top view illustration of UAV 100 while FIG. 1B is a bottom side plan view illustration of UAV 100.

The illustrated embodiment of UAV 100 includes a fuselage 120. In one embodiment, fuselage 120 is modular and includes a battery module, an avionics module, and a mission payload module. These modules are detachable from each other and mechanically securable to each other to contiguously form at least a portion of the fuselage 120 or UAV main body.

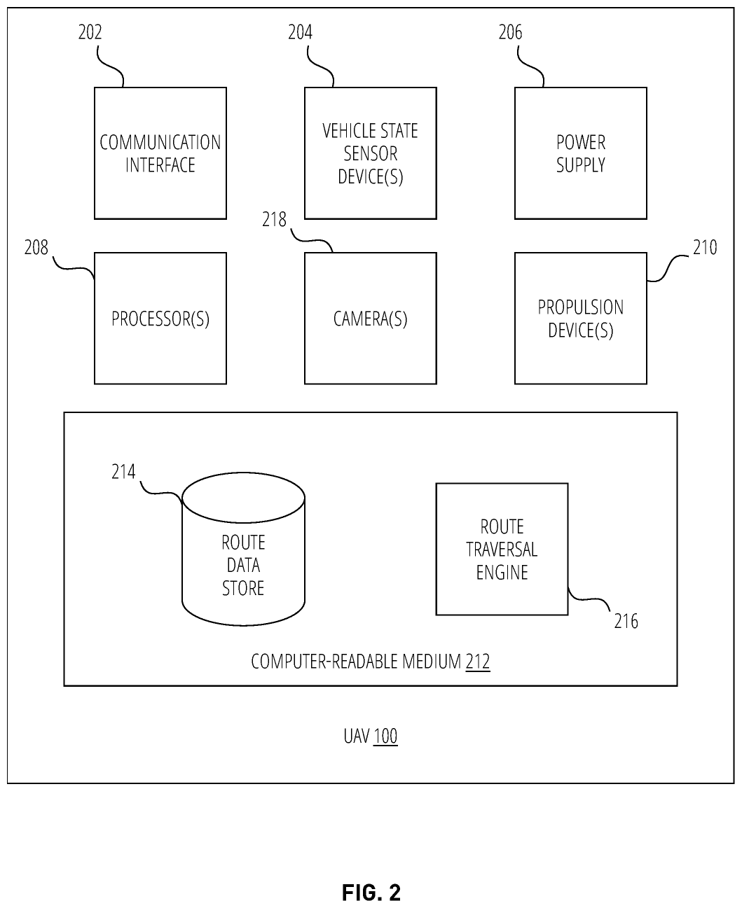

The battery module includes a cavity for housing one or more batteries for powering UAV 100. The avionics module houses flight control circuitry of UAV 100, which may include a processor and memory, communication electronics and antennas (e.g., cellular transceiver, Wi-Fi transceiver, etc.), and various sensors (e.g., global positioning sensor, an inertial measurement unit (IMU), a magnetic compass, etc.). The mission payload module houses equipment associated with a mission of UAV 100. For example, the mission payload module may include a payload actuator for holding and releasing an externally attached payload. In another embodiment, the mission payload module may include a camera/sensor equipment holder for carrying camera/sensor equipment (e.g., camera, lenses, radar, LIDAR, pollution monitoring sensors, weather monitoring sensors, etc.). Other components that may be carried by some embodiments of the UAV 100 are illustrated in FIG. 2.

The illustrated embodiment of UAV 100 further includes horizontal propulsion units 112 positioned on wing assembly 124, which can each include a motor, shaft, motor mount, and propeller, for propelling UAV 100. The illustrated embodiment of UAV 100 includes two boom assemblies 106 that secure to wing assembly 124.

The illustrated embodiments of boom assemblies 106 each include a boom housing 118 in which a boom is disposed, vertical propulsion units 108, printed circuit boards 116, and stabilizers 102. Vertical propulsion units 108 can each include a motor, shaft, motor mounts, and propeller, for providing vertical propulsion. Vertical propulsion units 108 may be used during a hover mode where UAV 100 is descending (e.g., to a delivery location) or ascending (e.g., following a delivery). Stabilizers 102 (or fins) may be included with UAV 100 to stabilize the UAV's yaw (left or right turns) during flight. In some embodiments, UAV 100 may be configured to function as a glider. To do so, UAV 100 may power off its propulsion units and glide for a period of time.

During flight, UAV 100 may control the direction and/or speed of its movement by controlling its pitch, roll, yaw, and/or altitude. For example, the stabilizers 102 may include one or more rudders 104 for controlling the UAV's yaw, and wing assembly 124 may include elevators for controlling the UAV's pitch and/or ailerons 110 for controlling the UAV's roll. As another example, increasing or decreasing the speed of all the propellers simultaneously can result in UAV 100 increasing or decreasing its altitude, respectively. The UAV 100 may also include components for sensing the environment around the UAV 100, including but not limited to audio sensor 122 and audio sensor 114. Further examples of sensor devices are illustrated in FIG. 2 and described below.

Many variations on the illustrated fixed-wing aerial vehicle are possible. For instance, aerial vehicles with more wings (e.g., an “x-wing” configuration with four wings), are also possible. Although FIG. 1A and FIG. 1B illustrate one wing assembly 124, two boom assemblies 106, two horizontal propulsion units 112, and six vertical propulsion units 108 per boom assembly 106, it should be appreciated that other variants of UAV 100 may be implemented with more or fewer of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

FIG. 2 is a block diagram that illustrates further components of a non-limiting example embodiment of a UAV according to various aspects of the present disclosure.

As shown, the UAV 100 includes a communication interface 202, one or more vehicle state sensor devices 204, a power supply 206, one or more processors 208, one or more cameras 218, one or more propulsion devices 210, and a computer-readable medium 212.

In some embodiments, the communication interface 202 includes hardware and software to enable any suitable communication technology for communicating with other devices, including but not limited to a flight planning computing system 310. In some embodiments, the communication interface 202 includes multiple communication interfaces, each for use in appropriate circumstances. For example, the communication interface 202 may include a long-range wireless interface such as a 4G or LTE interface, or any other type of long-range wireless interface (e.g., 2G, 3G, 5G, or WiMAX), to be used to communicate with a flight planning computing system 310 while traversing a route. The communication interface 202 may also include a medium-range wireless interface such as a Wi-Fi interface to be used when the UAV 100 is at an area near a start location or an endpoint where Wi-Fi coverage is available. The communication interface 202 may also include a short-range wireless interface such as a Bluetooth interface to be used when the UAV 100 is in a maintenance location or is otherwise stationary and waiting to be assigned a route. The communication interface 202 may also include a wired interface, such as an Ethernet interface or a USB interface, which may also be used when the UAV 100 is in a maintenance location or is otherwise stationary and waiting to be assigned a route.

In some embodiments, the vehicle state sensor devices 204 are configured to detect states of various components of the UAV 100, and to transmit signals representing those states to other components of the UAV 100. Some non-limiting examples of vehicle state sensor device 204 include a battery state sensor and a propulsion device health sensor. The vehicle state sensor devices 204 may also include a GNSS sensor, one or more accelerometers (and/or other devices that are part of an inertial navigation system), LIDAR devices, and/or other sensor devices for sensing an environment of the UAV 100.

In some embodiments, the power supply 206 may be any suitable device or system for storing and/or generating power. Some non-limiting examples of a power supply 206 include one or more batteries, one or more solar panels, a fuel tank, and combinations thereof. In some embodiments, the propulsion devices 210 may include any suitable devices for causing the UAV 100 to travel along the route. For an aircraft, the propulsion device 210 may include devices such as, but not limited to, one or more motors, one or more propellers, and one or more flight control surfaces.

In some embodiments, the processor 208 may include any type of computer processor capable of receiving signals from other components of the UAV 100 and executing instructions stored on the computer-readable medium 212. In some embodiments, the computer-readable medium 212 may include one or more devices capable of storing information for access by the processor 208. In some embodiments, the computer-readable medium 212 may include one or more of a hard drive, a flash drive, an EEPROM, and combinations thereof.

In some embodiments, the one or more cameras 218 may include any suitable type of camera for capturing imagery from the point of view of the UAV 100. For example, the cameras 218 may include one or more of a downward-facing camera or an angled-view camera. In some embodiments, the one or more cameras 218 may include one or more cameras of any type, including but not limited to a visible light camera, an infrared camera, a light-field camera, a laser camera, and a time-of-flight camera.

As shown, the computer-readable medium 212 has stored thereon a route data store 214 and a route traversal engine 216. In some embodiments, the route traversal engine 216 is configured to cause the propulsion devices 210 to autonomously propel the UAV 100 through a route received from a flight planning computing system 310 and stored in the route data store 214. The route traversal engine 216 may use signals from other devices, such as GPS sensor devices, vision-based navigation devices, accelerometers, LIDAR devices, and/or other devices that are not illustrated or described further herein, to assist in positioning and navigation as is typical for a UAV 100.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

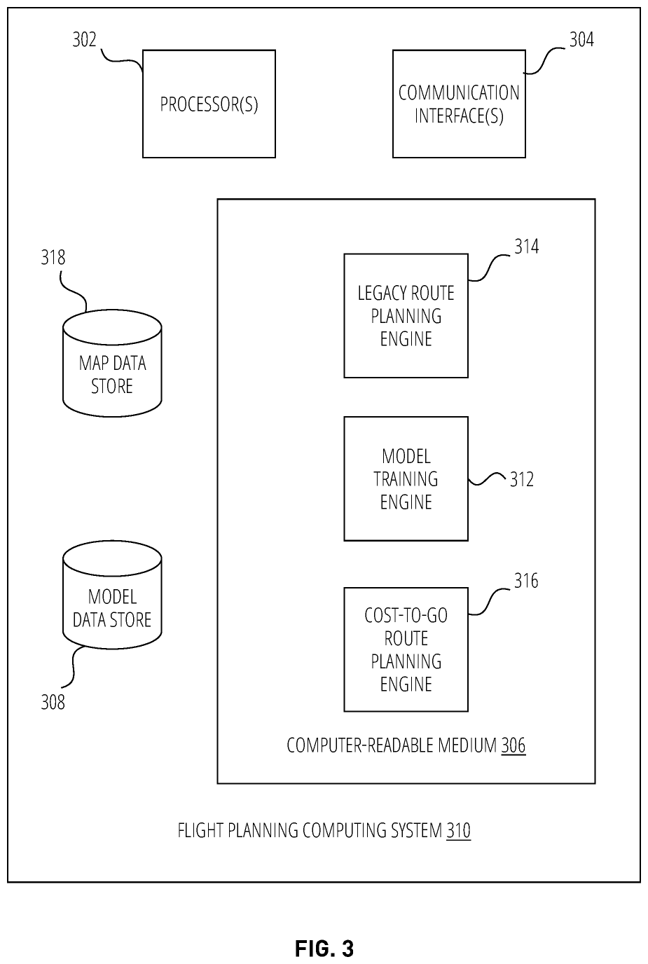

FIG. 3 is a block diagram that illustrates aspects of a non-limiting example embodiment of a flight planning computing system according to various aspects of the present disclosure. The illustrated flight planning computing system 310 may be implemented by any computing device or collection of computing devices, including but not limited to a desktop computing device, a laptop computing device, a mobile computing device, a server computing device, a computing device of a cloud computing system, and/or combinations thereof. The flight planning computing system 310 is configured to use a one-shot sampling technique to quickly answer feasibility queries and/or plan routes for a fleet of UAVs 100.

As shown, the flight planning computing system 310 includes one or more processors 302, one or more communication interfaces 304, a model data store 308, a map data store 318, and a computer-readable medium 306.

In some embodiments, the processors 302 may include any suitable type of general-purpose computer processor. In some embodiments, the processors 302 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 304 include one or more hardware and or software interfaces suitable for providing communication links between components. The communication interfaces 304 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 306 has stored thereon logic that, in response to execution by the one or more processors 302, cause the flight planning computing system 310 to provide a model training engine 312, a legacy route planning engine 314, and a cost-to-go route planning engine 316.

In some embodiments, the model training engine 312 is configured to train machine-learning models to generate cost-to-go maps for operation areas having map information stored in the map data store 318, and to store the trained machine-learning models in the model data store 308. In some embodiments, the legacy route planning engine 314 is configured to use a legacy sampling-based route planning technique to generate training data for the model training engine 312. In some embodiments, the cost-to-go route planning engine 316 is configured to use machine-learning models stored in the model data store 308 to generate cost-to-go maps for new missions, either to answer feasibility queries, to plan routes, or for any other reason.

Further description of the configuration of each of these components is provided below.

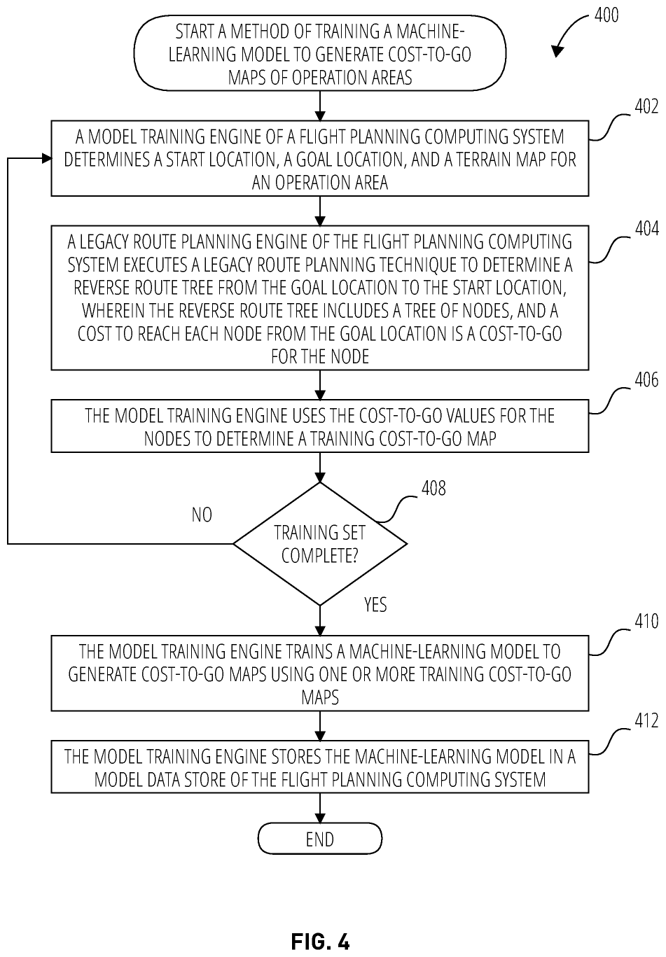

FIG. 4 is a flowchart that illustrates a non-limiting example embodiment of a method of training a machine-learning model to generate cost-to-go maps of operation areas according to various aspects of the present disclosure. A cost-to-go map provides a cost in some suitable measurement or measurements (e.g., one or more of a time to travel, distance, energy usage, vehicle wear, cumulative expected noise impact, a control effort, a cumulative proximity to obstacles, etc.) to navigate from locations within the map to a goal location. Once the machine-learning model is trained, it may be used to generate a cost-to-go map for an entire operation area in a single step, thus eliminating the need to use a slow, computing-intensive sampling technique to determine costs or to find navigation routes to the goal location.

From a start block, the method 400 proceeds to block 402, where a model training engine 312 of a flight planning computing system 310 determines a start location, a goal location, and a terrain map for an operation area. In some embodiments, the start location and the goal location may be randomly selected within an operation area in which the flight planning computing system 310 provides route planning services for a fleet of UAVs 100. In some embodiments, the start location and the goal location may be randomly selected from plausible candidate locations within the terrain map. As a non-limiting example, UAVs 100 may be based at a nest or other storage/deployment location, and may be used to pick up packages at pickup locations such as brick-and-mortar stores prior to dropping the packages off at houses or other suitable dropoff locations before returning to the nest. Since pickup and delivery missions may be planned in stages (e.g., a first stage with the nest as the start location and the pickup location as the goal location; a second stage with the pickup location as the start location and the dropoff location as the goal location; and a third stage with the dropoff location as the start location and the next as the goal location), the model training engine 312 may randomly choose any nest, pickup location, or dropoff location within the operation area as the start location, and may randomly choose any nest, pickup location, or dropoff location as the goal location. In some embodiments, the start location and/or the goal location may be in an operation area that is outside of the operation area in which the flight planning computing system 310 controls UAVs 100, in an attempt to train a machine-learning model capable of generating cost-to-go maps for multiple different operation areas instead of overfitting the machine-learning model to the operation area managed by the flight planning computing system 310.

In some embodiments, once the start location and the goal location are determined, the model training engine 312 retrieves an appropriate terrain map from the map data store 318 (e.g., terrain map information that includes at least the start location and the goal location). The terrain map represents characteristics of the operation area that may affect traversability of particular regions or may otherwise affect the routes to be taken by UAVs 100 to traverse from the start location to the goal location. For example, the terrain map may represent the altitude of the terrain, types of terrain (e.g., roads, structures, power lines, fields, bodies of water, etc.), weather conditions, or characteristics of the operation area that affect traversability.

In some embodiments, the terrain map may include a two-dimensional raster having a fixed spatial resolution, wherein each grid cell is associated with a maximum altitude value of the terrain within the grid cell. Borders of a flight area (or other flight restrictions) may be easily encoded into such a terrain map by setting the maximum altitude value outside of the flight area to a maximum allowed value, to a value higher than an operational ceiling of the UAVs 100, or with any other value suitable for indicating that the areas cannot be traversed.

In some embodiments, more complex representations may be used for the terrain map. For example, in some embodiments, a digital surface model (DSM) may be used to represent the terrain map. The DSM represents a surface of the Earth, including objects thereon, and may be represented as a vector-based triangular irregular network (TIN) or using any other suitable data structure. As another example, instead of a two-dimensional raster, a point cloud could be used to represent the terrain, or a function approximation technique, including but not limited to a PointNet model, could be used to extract features to be used as the terrain map from another data format such as a point cloud.

At block 404, a legacy route planning engine 314 of the flight planning computing system 310 executes a legacy route planning technique to determine a reverse route tree from the goal location to the start location, wherein the reverse route tree includes a tree of nodes, and a cost to reach each node from the goal location is a cost-to-go for the node. Each node is associated with a location within the terrain map. In some embodiments, each node represents a state vector of a simulated UAV 100, and may include representations of one or more aspects of a state including, but not limited to, one or more of a position, a speed, an acceleration, a heading, an orientation, a payload weight, or a battery state of charge. Typically, legacy route planning techniques determine locations to be used as nodes randomly.

In some embodiments, an iterative sampling technique may be used to determine the reverse route tree. As one non-limiting example, an RRT* technique may be used, starting with the goal location as the start. In such a technique, a tree is built starting from a node at the goal location. The technique iteratively chooses a location for a new node, connects the new node to an existing node of the tree, and then optimally rewires at least some of the nodes of the tree in the neighborhood of the new node. In the RRT* technique, the tree grows randomly to explore the entirety of the terrain map, and once a feasible path exists from a node in the tree to the start location, a node is created at the start location and connected to the node in the tree, and the reverse route tree is considered complete. The edges connecting nodes of the tree may be straight lines in order to indicate shortest paths between nodes, may be Dubins paths that include sequences of fixed-radius arcs and straight line paths in order to more closely represent the motion of a UAV 100, may be polynomial trajectories, may be closed loop vehicle model simulated trajectories, or may be any other suitable shape. Each edge connecting two nodes in the tree encodes the cost to reach that node. As such, by adding together the values of the edges from the node at the goal location to any other node of the tree, the “cost-to-go” from that other node to the goal location can be obtained.

At block 406, the model training engine 312 uses the cost-to-go values for the nodes to determine a training cost-to-go map. The method 400 then proceeds to a decision block 408, where a determination is made regarding whether enough training cost-to-go maps have been generated to complete the training set. Typically, more than one training cost-to-go map will be desired in order to avoid overfitting the machine-learning model to the specific case of a given start location and/or goal location. Likewise, additional training cost-to-go maps may be desired in different operation areas to help avoid overfitting the machine-learning model to the initial operation area. By generating a plurality of reverse route trees using the legacy route planning technique (even for the same terrain map), a large number of cost-to-go values may be determined, such that an adequate amount of data is available for training the machine-learning model. The determination may be made on any suitable basis, including but not limited to one or more of whether a threshold number of training cost-to-go maps has been reached, a threshold number of nodes has been reached, a desired set of terrain maps have been processed, or any other suitable threshold has been reached.

Accordingly, if it is determined that more training cost-to-go maps should be generated, then the result of decision block 408 is NO, and the method 400 returns to block 402 to generate another training cost-to-go map based on at least one of a different start location and a different goal location. Otherwise, if enough training cost-to-go maps have been generated, then the result of decision block 408 is YES, and the method 400 proceeds to block 410, where the model training engine 312 trains a machine-learning model to generate cost-to-go maps using one or more training cost-to-go maps. The machine-learning model may accept a terrain map, a start location, and a goal location as input, and may output a cost-to-go map as output. As such, the training cost-to-go maps may serve as labels for desired cost-to-go values to be learned given the input of the terrain map, the start location, and the goal location. While the training cost-to-go maps may have cost-to-go values at discrete points within the terrain map due to the nature of the legacy route planning technique used, in some embodiments, the machine-learning model may smoothly interpolate between discrete points within the terrain map. Any suitable architecture may be used for the machine-learning model, including but not limited to an artificial neural network such as a convolutional neural network. Likewise, any suitable technique may be used for training the machine-learning model, including but not limited to gradient descent and/or an Adam optimizer.

At block 412, the model training engine 312 stores the machine-learning model in a model data store 308 of the flight planning computing system 310. The method 400 then proceeds to an end block and terminates.

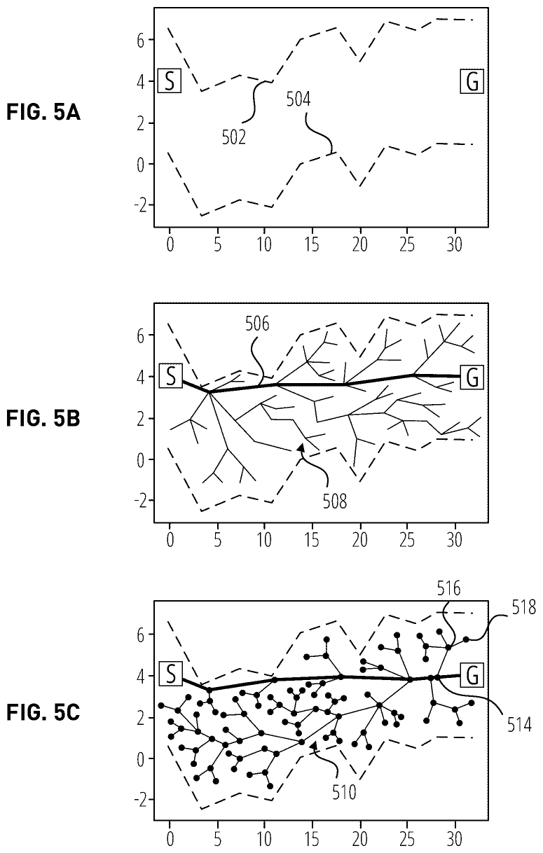

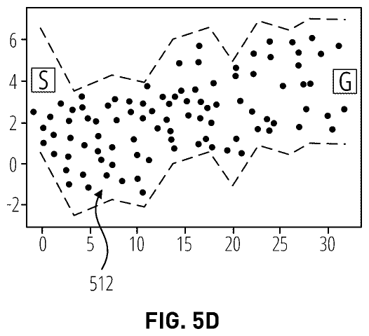

FIG. 5A-FIG. 5D are simplified schematic illustrations of a non-limiting example embodiment of the determination of a cost-to-go map according to various aspects of the present disclosure.

In FIG. 5A, a greatly simplified illustration of a terrain map is shown. The illustrated terrain map is a two-dimensional cross section of an operation area, and shows a start location (the box labeled “S”) and a goal location (the box labeled “G”). A lower limit 504 represents a minimum allowable altitude for a UAV 100 within the operation area, which may be the surface altitude, a buffer above the surface altitude, or any other minimum allowable altitude. An upper limit 502 represents a maximum allowable altitude for a UAV 100 within the operation area, which may be a maximum altitude above the surface in order to deconflict from other air traffic.

In FIG. 5B, determination of a route using a legacy route planning technique is shown. The legacy route planning technique, such as RRT*, creates a tree starting from the start location that randomly explores the terrain map until an end condition is met. If the tree reaches the goal location, then a path from the start location to the goal location through the tree is a potential navigation route, and may be an optimal route or close to an optimal route. As shown in FIG. 5B, an optimal route 506 as well as the tree of additional sampled nodes 508, have been determined. Though only a few additional sampled nodes 508 are shown, legacy route planning techniques will typically create hundreds or thousands of additional sampled nodes 508 when exploring the terrain map prior to finding the optimal route 506, thus illustrating the inefficiencies in these previous techniques.

FIG. 5C illustrates the determination of a reverse route tree, as described in block 404. Instead of starting the legacy route planning technique at the start location, in FIG. 5C, the legacy route planning technique bases its tree at the goal location. A plurality of sampled nodes are illustrated, and as with FIG. 5B, though only a few sampled nodes are shown, tens, hundreds, or thousands of sampled nodes may actually be determined in creating the reverse route tree.

The reverse route tree 510 connects a plurality of nodes. For example, with RRT*, nodes are randomly sampled, connected to an existing node of the tree at a predetermined distance in order to grow the tree into unexplored areas, and nodes are then rewired to optimize distances of all nodes from the root of the tree. The length of the edges between nodes is associated with a cost to travel between the nodes. As such, by adding the edges from a given node to the goal location, the cost-to-go value for the given node can be obtained.

For example, assuming that the cost for traversing each edge is one, the cost to traverse from the goal location to a first node 514 is one, the cost to traverse from the goal location to a second node 516 is two, and the cost to traverse from the goal location to a third node 518 is three, meaning that the cost-to-go value for the third node 518 is three, the cost-to-go value for the second node 516 is two, and the cost-to-go value for the first node 514 is one. Likewise, the cost-to-go value for the start location would be seven, as there are seven edges on the route that connects the start location and the goal location.

Once cost-to-go values are determined using the legacy route planning technique, the cost-to-go values are assigned to the nodes. FIG. 5D illustrates the plurality of cost-to-go values 512 from the terrain map of FIG. 5C. Naturally, as there may be a larger number of nodes determined that were not illustrated in FIG. 5C, there may also be a larger number of cost-to-go values 512 in FIG. 5D. This plurality of cost-to-go values 512 is an example that may be used in the training data at block 410.

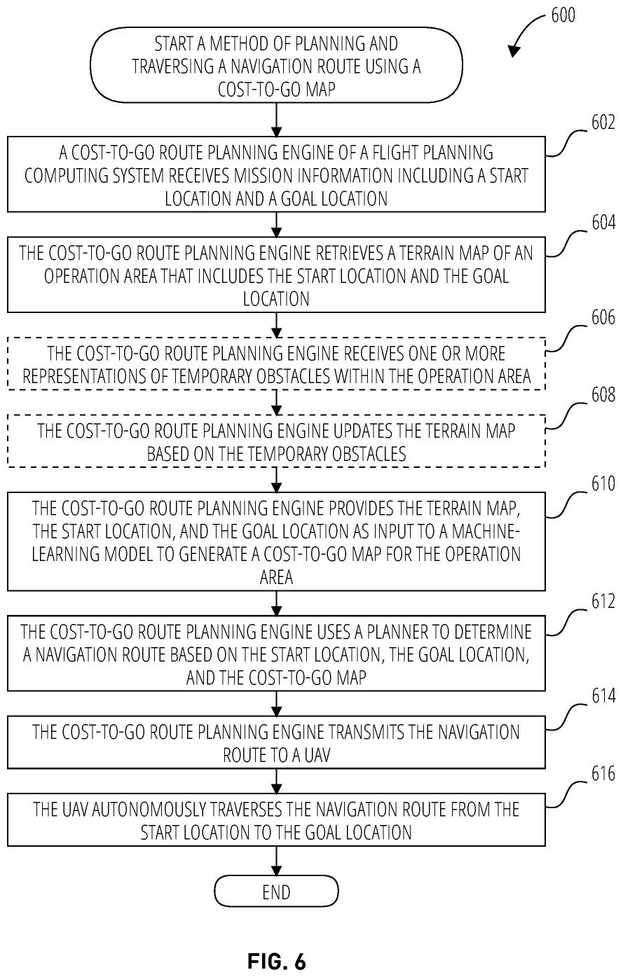

FIG. 6 is a flowchart that illustrates a non-limiting example embodiment of a method of planning and traversing a navigation route using a cost-to-go map according to various aspects of the present disclosure. Instead of using an iterative technique to sample the operation area and determine a feasible route, the method 600 uses a machine-learning model such as those trained in the method 400 described above in order to generate a cost-to-go map for the operation area, and then uses the cost-to-go map to answer feasibility queries and/or determine a route without having to spend the time to perform multiple sampling iterations or create a tree to explore the entire operation area to find the route.

From a start block, the method 600 proceeds to block 602, where a cost-to-go route planning engine 316 of a flight planning computing system 310 receives mission information including a start location and a goal location. In some embodiments, the mission information may include information in addition to the start location and the goal location, including but not limited to a desired time of departure, a desired time of arrival, one or more waypoints, one or more activities to be performed along the route, and/or any other type of information describing the mission. For example, in some embodiments, the mission information may include a pickup location to be visited to pick up a package, and a dropoff location to be visited to drop off the package prior to traveling to the goal location (which may coincide with the start location, if the UAV 100 is to return to a nest or other location from which it started). In some embodiments, such multi-leg missions may be planned as separate missions (e.g., a first mission from the start location to the pickup location, a second mission from the pickup location to the dropoff location, and a third mission from the dropoff location to the goal location) for the sake of simplicity, and feasibility queries may be answered by determining whether all of the separate missions are feasible. For package delivery missions, the mission information may include information describing the package that may affect the cost of travel for the UAV 100 while carrying the package, including but not limited to dimensions of the package and a weight of the package.

At block 604, the cost-to-go route planning engine 316 retrieves a terrain map of an operation area that includes the start location and the goal location. In some embodiments, the cost-to-go route planning engine 316 may query the map data store 318 for a terrain map that includes the start location and the goal location. In some embodiments, the map data store 318 may provide an entire terrain map that includes the start location and the goal location, even if the terrain map includes a large area outside of likely feasible paths, in order to avoid re-computing a smaller terrain map from a larger set of data. In some embodiments, the map data store 318 may extract a smaller terrain map from a larger set of data such that it includes the start location, the goal location. For example, the map data store 318 may extract a rectangular, elliptical, or other-shaped portion of a larger set of data that nevertheless includes the start location and the goal location in order to reduce the amount of computation used while planning the route.

At optional block 606, the cost-to-go route planning engine 316 receives one or more representations of temporary obstacles within the operation area. The cost-to-go route planning engine 316 may query one or more data stores to retrieve the representations of temporary obstacles, may receive push transmissions of the representations of temporary obstacles from various sources, or may obtain the representations of the temporary obstacles in any other suitable way. One non-limiting example of a temporary obstacle includes a temporary flight restriction, obstruction, or other relevant information received from a regulatory agency, such as via a Notice to Airmen/Noticed to Air Missions (NOTAM) message. Another non-limiting example of a temporary obstacle is a timed space reservation, which is a space that is reserved by the flight planning computing system 310 for a given UAV 100 to operate within during a given time period, such that routes planned by the flight planning computing system 310 do not conflict with each other. Typically, a representation of a temporary obstacle will include a two-dimensional area or three-dimensional volume affected by the obstacle, as well as a start time and end time at which the obstacle will be present. In some embodiments, the temporary obstacle may be represented by a Volume4 shape, which may either be directly received by the cost-to-go route planning engine 316 or may be created by the cost-to-go route planning engine 316 from data provided in another format.

At optional block 608, the cost-to-go route planning engine 316 updates the terrain map based on the temporary obstacles. In some embodiments, this update may occur by adding the Volume4 shapes (or other representations of the obstacles) directly to the terrain map. In some embodiments, this update may occur by determining portions of the terrain map that correspond to the locations of the obstacles and updating the existing data in the terrain map to make those locations impassible. For example, the terrain map may be updated in the areas of the obstacles to have an altitude that is beyond the flight envelope or permitted elevations for the UAVs 100. In some embodiments, the updates to the terrain map may also include indications of times during which the obstacles will be present. In some embodiments, the cost-to-go route planning engine 316 may check whether the start time and end time for a given obstacle overlap with the desired time of departure and/or the desired time of arrival, and may refrain from updating the terrain map based on a given obstacle if it is determined that the obstacle will not be present during the mission.

Blocks 606 and 608 are illustrated as optional because for some missions, there may not be any temporary obstacles present in the operation area. For such missions, the cost-to-go route planning engine 316 may query for representations of temporary obstacles at optional block 606 and move on to block 610 after failing to find any, or may move directly from block 604 to block 610 if no representations of temporary obstacles had been received via push transmissions.

At block 610, the cost-to-go route planning engine 316 provides the terrain map, the start location, and the goal location as input to a machine-learning model to generate a cost-to-go map for the operation area. The cost-to-go route planning engine 316 may retrieve the machine-learning model from the model data store 308 that was previously trained using the method 400 described above. As when creating the training cost-to-go maps, the terrain map may be provided as input to the machine-learning model using a 2D raster, a DSM, a PointNet, or any other suitable representation/data structure.

In some embodiments, the output of the machine-learning model is a cost-to-go map that provides cost-to-go information for locations of the terrain map. In some embodiments, the cost-to-go information may include a scalar value that represents a cost to travel from a given point to the goal location. In some embodiments, the cost-to-go information may include a vector of multiple costs, including but not limited to two or more of an energy usage, a travel time, a distance, a cumulative expected noise impact, a control effort, a cumulative proximity to obstacles, an effect on other planned routes in the operation area, or other measurements of costs of traversing a route. In some embodiments, the cost-to-go map may provide a raster, grid, or other discrete representation of cost-to-go values. In some embodiments, the cost-to-go map may interpolate between discrete values such that the cost-to-go value from any point in the cost-to-go map may be requested with a high degree of precision. In some embodiments, the cost-to-go map output by the machine-learning model may also include, for each point, a direction of the steepest descent in cost-to-go values, to further reduce the calculations used in the route determination step.

At block 612, the cost-to-go route planning engine 316 uses a planner to determine a navigation route based on the start location, the goal location, and the cost-to-go map. Any suitable planner that uses the cost-to-go values may be used. In some embodiments, a planner that operates in a discrete-time Markov Decision Process may be used. Such a planner may involve using a state space that includes a position (R³), velocity (speed in R¹ and direction in Si), and energy consumed (R′); an action space that includes coordinates of its next candidate position (R³); a deterministic state transition matrix wherein the next state is derived from the action; and a cost function wherein the cost of an action is a linear combination of the energy consumed to reach the next state from the current state and a collision cost which equals infinity if there is a collision with an obstacle and zero otherwise.

Since the cost-to-go values already encode a cost-based policy, some embodiments may simply start at the start location and follow a path of steepest descent in the cost-to-go values to determine the route to the goal location. If the cost-to-go map includes indications of the direction of steepest descent, these indications can be used directly to determine the route without significant further computation. Even if the cost-to-go map does not include such indications, the direction of steepest descent may be determined by sampling several neighboring points and choosing the neighboring point having the lowest cost-to-go value. Despite sampling multiple neighboring points, this technique is still a massive improvement in computing speed compared to the legacy sampling-based techniques, at least because the first determined route is likely to be very close to an optimal route, and so multiple candidate routes need not be determined. This is in stark contrast to the legacy sampling techniques, in which hundreds, if not thousands, of iterations may be used to explore the entire operation area in the hope of determining a reasonably optimal route.

One will also note that, though not illustrated as part of the method 600, the answering of feasibility queries from a cost-to-go map generated for a start location and a goal location is trivial. A capability of a UAV 100 (e.g., an energy capacity/available range, etc.) or a limitation on UAV 100 operation (e.g., a cumulative noise impact, etc.) may be compared to the corresponding cost-to-go value at the start location, and this comparison directly answers whether there is a feasible route from the start location to the goal location for the UAV 100—if the cost-to-go value is greater than the corresponding capability of the UAV 100, then there is not a feasible route for the UAV 100 since the comparison indicates that the UAV 100 would not be able to complete the route.

At block 614, the cost-to-go route planning engine 316 transmits the navigation route to a UAV 100, and at block 616, the UAV 100 autonomously traverses the navigation route from the start location to the goal location. In some embodiments, the cost-to-go route planning engine 316 may store the navigation route for later transmission to the UAV 100, or perform other processing related to flight planning for a fleet of UAVs 100 using the navigation route. For example, the flight planning computing system 310 may store one or more timed space reservations based on the navigation route to avoid conflicts between UAVs 100 concurrently traversing navigation routes within the operation area.

The method 600 then proceeds to an end block and terminates.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of planning a navigation route for an autonomous vehicle, the method comprising:
receiving, by a computing system, mission information including a start location and a goal location;
generating, by the computing system, a representation of an operation area that includes the start location and the goal location;
updating, by the computing system, the representation of the operation area based on one or more temporary obstacles;
providing, by the computing system, the representation of the operation area, the start location, and the goal location as input to a machine-learning model to generate a cost-to-go map of the operation area; and
determining, by the computing system, the navigation route using the cost-to-go map of the operation area.

2. The method of claim 1, wherein the temporary obstacles are represented by one or more Volume4 shapes.

3. The method of claim 2, wherein the obstacles include one or more of a temporary flight restriction or a timed space reservation for another autonomous vehicle.

4. The method of claim 1, wherein the representation of the operation area includes a raster representation, a digital surface model representation, or a representation generated by a function approximation technique.

5. The method of claim 1, wherein the cost-to-go map generated by the machine-learning model includes a direction of steepest descent for each point.

6. The method of claim 1, wherein the machine-learning model is trained by:
executing a route planning technique using the goal location as a start node and the start location as a goal node to generate cost-to-go values for nodes of the operation area; and
using the cost-to-go values as labels for a set of training data that includes the terrain map and the goal location for training the machine-learning model.

7. The method of claim 1, wherein determining the navigation route using the cost-to-go map of the operation area includes selecting nodes based on a direction of steepest descent of the cost values of the cost-to-go map.

8. The method of claim 1, wherein cost values of the cost-to-go map include vectors representing one or more of energy usage to reach the goal location, a time to reach the goal location, a cumulative expected noise impact, a control effort, or a cumulative proximity to obstacles.

9. The method of claim 1, further comprising transmitting the navigation route to the autonomous vehicle to be used for autonomous navigation from the start location to the goal location.

10. The method of claim 1, wherein the autonomous vehicle is an autonomous aerial vehicle (UAV).

11. A non-transitory computer-readable medium having computer-executable instructions stored thereon that, in response to execution by one or more processors of a computing system, cause the computing system to perform actions for planning a navigation route for an autonomous vehicle, the actions comprising:
receiving, by the computing system, mission information including a start location and a goal location;
generating, by the computing system, a representation of an operation area that includes the start location and the goal location;
updating, by the computing system, the representation of the operation area based on one or more temporary obstacles;
providing, by the computing system, the representation of the operation area, the start location, and the goal location as input to a machine-learning model to generate a cost-to-go map of the operation area; and
determining, by the computing system, the navigation route using the cost-to-go map of the operation area.

12. The computer-readable medium of claim 11, wherein the temporary obstacles are represented by one or more Volume4 shapes.

13. The computer-readable medium of claim 12, wherein the obstacles include one or more of a temporary flight restriction or a timed space reservation for another autonomous vehicle.

14. The computer-readable medium of claim 11, wherein the representation of the operation area includes a raster representation, a digital surface model representation, or a representation generated by a function approximation technique.

15. The computer-readable medium of claim 11, wherein the cost-to-go map generated by the machine-learning model includes a direction of steepest descent for each point.

16. The computer-readable medium of claim 11, wherein the machine-learning model is trained by:
executing a route planning technique using the goal location as a start node and the start location as a goal node to generate cost-to-go values for nodes of the operation area; and
using the cost-to-go values as labels for a set of training data that includes the terrain map and the goal location for training the machine-learning model.

17. The computer-readable medium of claim 11, wherein determining the navigation route using the cost-to-go map of the operation area includes selecting nodes based on a direction of steepest descent of the cost values of the cost-to-go map.

18. The computer-readable medium of claim 11, wherein cost values of the cost-to-go map include vectors representing one or more of energy usage to reach the goal location, a time to reach the goal location, a cumulative expected noise impact, a control effort, or a cumulative proximity to obstacles.

19. The computer-readable medium of claim 11, wherein the actions further comprise transmitting the navigation route to the autonomous vehicle to be used for autonomous navigation from the start location to the goal location.

20. The computer-readable medium of claim 11, wherein the autonomous vehicle is an autonomous aerial vehicle (UAV).
